(19) United States
(12) Patent Application Publication
(10) Pub. No.: US 2013/0214456 A1
(43) Pub. Date: Aug. 22, 2013

(54) Apparatus and Method of Manufacturing Objects with Varying Concentration of Particles

(71) Applicant: Udayan Kanade, Pune (IN)

(72) Inventor: Udayan Kanade, Pune (IN)

(73) Assignee: I2IC CORPORATION, Foster City, CA (US)

(21) Appl. No.: 13/880,070

(22) PCT Filed: Oct. 19, 2011
(86) PCT No.: PCT/IB11/54676

§ 371 Date: Apr. 18, 2013

(30) Foreign Application Priority Data
Oct. 19, 2010 (IN) 2904/MUM/2010

(51) Int. Cl. B29C 45/18

(52) U.S. Cl. CPC B29C 45/1808
USPC 264/328.18; 425/130

(57) ABSTRACT

An apparatus and method for manufacturing an object with a varying concentration of particles, with a defined concentration profile are disclosed. In an embodiment, the object with varying concentration of particles is manufactured by mixing liquids comprising different particle concentrations, the proportion in which such liquids are mixed being varied over time. The resultant liquid is cast or extruded into the required shape to form the object with a varying concentration of particles.

This application claims priority from provisional patent application 2904/MUM/2010 titled “Method of Manufacturing of Objects with Varying Concentration of Particles” filed in Mumbai, India on 19 Oct. 2010.

### TECHNICAL FIELD

### Technical Field

The present invention relates to materials. More particularly, it relates to manufacturing of objects of materials with varying concentrations of particles of a second material.

### BACKGROUND ART

### Background Art

Objects, particularly rods or sheets of a first material with particles of a second material embedded within them are used for various purposes in the art. Such particles may cause a change in some property of the object such as strength, brittleness, heat resistance, etc. which are beneficial for various purposes. Rods and sheets with particles are also used for optical purposes. For example, a transparent rod or sheet may have particles of a different refractive index embedded in it. The transparent rod or sheet acts as a light guide, and the embedded particles disperse the guided light. This apparatus can be used as a light source. The particles may be dyes added to impart color to the sheet.

### SUMMARY

An apparatus and method for manufacturing an object with a varying concentration of particles, with a defined concentration profile are disclosed. In an embodiment, the object with varying concentration of particles is manufactured by mixing liquids comprising different particle concentrations, the proportion in which such liquids are mixed being varied over time. The resultant liquid is cast or extruded into the required shape to form the object with a varying concentration of particles.

The above and other preferred features, including various details of implementation and combination of elements are more particularly described with reference to the accompanying drawings and pointed out in the claims. It will be understood that the particular methods and systems described herein are shown by way of illustrations only and not as limitations. As will be understood by those skilled in the art, the principles and features described herein may be employed in various and numerous embodiments without departing from the scope of the invention.

### BRIEF DESCRIPTION OF THE DRAWINGS

The accompanying drawings, which are included as part of the present specification, illustrate the presently preferred embodiment and together with the general description given above and the detailed description of the preferred embodiment given below service to explain and teach the principles of the present invention.

FIG. 1 illustrates a block diagram of a system for manufacturing an object with varying concentration of particles, according to an embodiment.

FIG. 2 illustrates a system for manufacturing objects with varying concentration of particles, according to an embodiment.

FIG. 3 illustrates a system for manufacturing objects with varying concentration of particles, according to an embodiment.

FIG. 4 illustrates a system for manufacturing objects with varying concentration of particles, according to an embodiment.

FIG. 5 illustrates a block diagram of an exemplary sheet die, according to one embodiment.

FIG. 6 illustrates a block diagram of an injection molding apparatus for manufacturing objects with varying concentration of particles, according to an embodiment.

FIG. 7 illustrates a block diagram of a mixing manifold that mixes two streams of liquids, according to one embodiment.

FIG. 8 illustrates a block diagram of a mixing manifold that mixes two streams of liquids, according to one embodiment.

FIG. 9 illustrates a block diagram of a mixing manifold that mixes two streams of liquids, according to one embodiment.

FIG. 10 illustrates a method of manufacturing an object with a varying concentration of particles, according to one embodiment.

### DETAILED DESCRIPTION

An apparatus and method for manufacturing an object with a varying concentration of particles, with a defined concentration profile are disclosed. In an embodiment, the object with varying concentration of particles is manufactured by mixing liquids comprising different particle concentrations, the proportion in which such liquids are mixed being varied over time. The resultant liquid is cast or extruded into the required shape to form the object with a varying concentration of particles.

FIG. 1 illustrates a block diagram of a system for manufacturing an object with varying concentration of particles 199, according to an embodiment. A device 110 produces material of particle concentration 103. Another device 120 produces material of particle concentration 105. Particle concentration 105 is usually a different particle concentration than particle concentration 103. In an embodiment, the devices 110 and 120 may be extruders or injection molding machines. The devices 110 and 120 may be any machines which can dispense materials at rates which can be changed, or at pressures which can be changed. The two materials are mixed together in a mixing device 130 to give material of particle concentration 107. In an embodiment, the mixing device 130 may be an extruder, a mixing manifold, or a channel or system of channels that mixes material. Any of the concentrations could be a zero concentration. In an embodiment, concentrations 103 and 105 are made variable with respect to time. Thus the desired concentration 107 is obtained at the output of mixing device 130. In another embodiment, materials of concentrations 103 and 105 are mixed in different proportions in the mixing device 130. The amount of each material being mixed at a particular moment is varied with time, to give a concentration at the output of mixing device 130 that varies with time.

In an embodiment, the mixed material is extruded or molded using a process such as extrusion or injection molding to produce a final solid product.

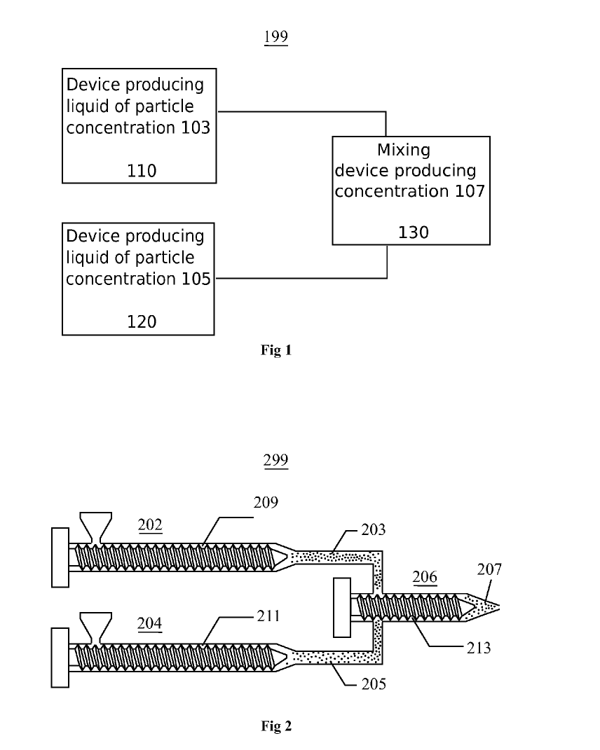

FIG. 2 illustrates a system for manufacturing objects with varying concentration of particles 299, according to an embodiment. Material of particle concentration 203 is obtained using a screw extruder 202. Material of particle concentration 205 is obtained using another screw extruder 204. The outputs of these two screw extruders are connected to a mixing device, such as a screw extruder 206. The screw extruder 206 is fed liquid or liquified material from the two screw extruders 202 and 204. This material is churned by screw 213 to produce a homogeneous material.

Either one or both of 203 and 205 could be a zero concentration (i.e. one with no particles inside it). The rate of extrusion of material of particle concentration 203 could be made variable with time by varying the speed of rotation of the screw 209. The rate of extrusion of material of particle concentration 205 could also be made variable with time by varying the speed of rotation of the screw 211. The screw speeds of extruder 202 and extruder 204 could be same or different. The outputs of extruder 202 and extruder 204 are given as inputs to extruder 206. Extruder 206 mixes the materials with particle concentration 203 and 205 to produce material with output particle concentration 207. The output particle concentration 207 could be fixed or varying with time.

The speed of rotation of screw 213 of extruder 207 decides the output flow rate. According to an embodiment, the output flow rate of extruder 206 is set to the sum of the output flow rates of extruders 202 and 204. Alternatively, the output flow rates of extruders 202 and 204 are set such that their sum is the output flow rate of extruder 206. The speed of rotation of screws 209 and 211 set the output flow rates of extruders 202 and 204 respectively. The output flow rate is also decided by other factors such as size and design of the screw, size and design of the extruder, etc. The output flow rates of extruders 202 and 204 are varied over time. The ratio of output flow rates of extruders 202 and 204 at a given instant produces material of a particular concentration at the input of extruder 206. As the ratio of the output flow rates is varied over time, the concentration at the input of extruder 206 varies. This creates a varying concentration at the output of extruder 206.

The two input extruders 202 and 204 are made to output material of different particle concentrations. This is done by feeding each input extruder, material having different particle concentrations. In an embodiment, pure base material and particulate material is fed in accurate amounts to the feeder (hopper) that feeds the screw of the input extruder. In another embodiment, pure base material has particulate material embedded in it, at a predefined concentration level. This may be done, for example, by master-batching, or creating the composite material using a different extrusion or mixing process where the two materials are mixed. In a third embodiment, pellets of pure base material and base material with particulate material embedded in it are both fed to the feeder in accurate amounts. In all the above methods, choosing the appropriate amounts of the two species being fed will create an appropriate particle concentration in the input extruder. The extruder screw will thoroughly mix the two fed species to evenly distribute the particulate material in the base material. In an embodiment the material fed to the input extruders is in solid form. The material is heated and/or pressurized and churned by the action of the screws to produce a liquid at the output of the input extruders.

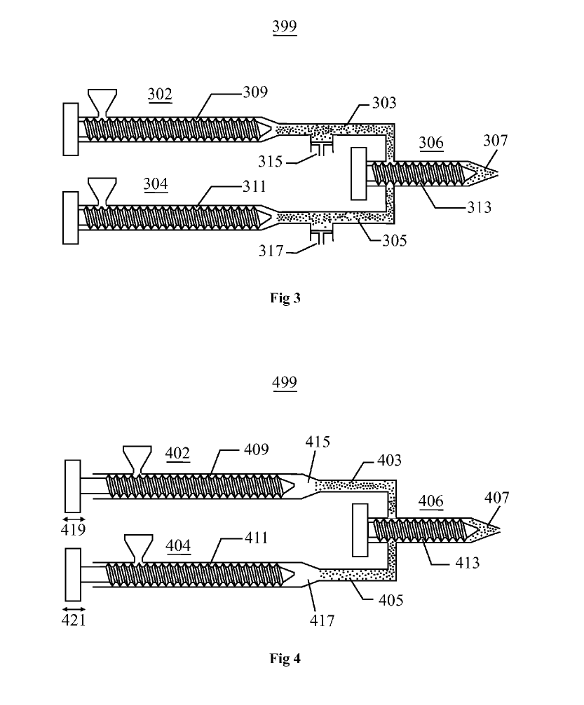

FIG. 3 illustrates a system for manufacturing objects with varying concentration of particles 399, according to an embodiment. Material of particle concentration 303 is obtained using an extruder 302. Material of particle concentration 305 is obtained using another extruder 304. These feeding extruders (302 and 304) may have screws 309 and 311. The outputs of these two extruders are mixed in an extruder 306. Either one or both of 303 and 305 could be a zero concentration (i.e. one with no particles inside it). A chamber with a piston (315 or 317) is attached to the channel connecting the feeding extruder to the mixing extruder 306. The output flow rate of material of particle concentration 303 could be varied by moving piston 315 up or down with time. The output flow rate of material of particle concentration 305 could be varied by moving piston 317 up or down with time. The piston 315 could be moved in unison with piston 317. The unison could be in such a way that when one piston moves up, the other moves down. In one embodiment, piston 315 and piston 317 are connected mechanically. The materials of particle concentration 303 and concentration 305 are given as inputs to extruder 306 which mixes them to produce material of output concentration 307.

According to an embodiment, the output flow rate of material of particle concentration 303 is the sum of the rate of extrusion of material due to the extruder 302 (itself a function of the speed of rotation of screw 309) and an additive rate due to the piston 315. The additive rate due to the piston 315 is proportional to the velocity of the piston. In an embodiment, the additive rate is the product of the velocity of the piston, the surface area of the piston and density of the material being extruded. This additive rate due to the piston is positive if the piston is moving in towards the material channel and negative if the piston is moving away from the channel. By controlling the velocity of the piston 315, the additive rate and hence the rate of output of material of particle concentration 303 can be controlled. Similarly by controlling the velocity of piston 317, the rate of output of material of particle concentration 305 can be controlled.

To get a repetitive (periodic) concentration profile (concentration pattern), the velocity of the pistons is changed in a periodic manner. The pistons cycle through both positive and negative velocities in such a way that at the end of the pattern, they are in the same position as in the beginning.

FIG. 4 illustrates a system for manufacturing objects with varying concentration of particles 499, according to an embodiment. Material of particle concentration 403 is obtained using a screw extruder 402. Material of particle concentration 405 is obtained using another screw extruder 404. The outputs of these two screw extruders are mixed in a screw extruder 406. Either one or both of 403 and 405 could be a zero concentration (i.e. one with no particles inside it). The screws 409 and 411 are reciprocating screws, i.e. they can move forward and backward in their respective cavities. The concentration 403 and concentration 405 could be made variable with time. In one embodiment, the rate of extrusion of particle concentration 403 could be varied by varying the flow rate of the material by moving the screw 409 in direction 419 inside cavity 415. The rate of extrusion of particle concentration 405 could be varied by varying the flow rate of the material by moving the screw 411 in direction 421 inside cavity 417. The materials of particle concentration 403 and concentration 405 are given as inputs to extruder 406 which mixes them to produce material of output concentration 407.

The output flow rate of material of particle concentration 403 is dependent on the speed of rotation of screw 409, as well as the velocity at which it is moving forward or backward in the extruder cylinder. One or both of these may be varied to vary the rate of output of material. Similarly output flow rate of material of particle concentration 405 is varied.

In an embodiment, the reciprocating motion and the rotary motion of the screws are alternated. The rotary motion creates a heated liquid at the end of the screw, and a forward motion of the screw sends the material forward to the material mixing. The velocity of such forward motion is different at different times, so that material from the two screw extruders mixes in different proportions at different times.

In an embodiment, there may also be attached a cylinder with a reciprocating piston to the channel between the extruders 402 and 404, and the mixing extruder 406. The velocity of the piston affects the output flow rate, as recited previously.

FIG. 5 illustrates a block diagram of an exemplary sheet die 599, according to one embodiment. The liquid 501 bifurcates in two branches at point 511. Similarly it bifurcates further at points such as 513, 515 and 517. Channels such as 503, 505, 507 and 509 channel the liquid 501 from the inlet to the end of the die. At the end of the die, the channels merge to form one sheet of liquid. In this way, liquid is conducted from the inlet to the sheet extrusion orifice such that all liquid will go through the same or similar distance of travel before being extruded. In this way, if a variable concentration stream of liquid is entering the sheet die 599, it will create a sheet of graded concentration, where various portions extruded at any given moment (horizontal positions on the sheet) will have same or almost same concentration.

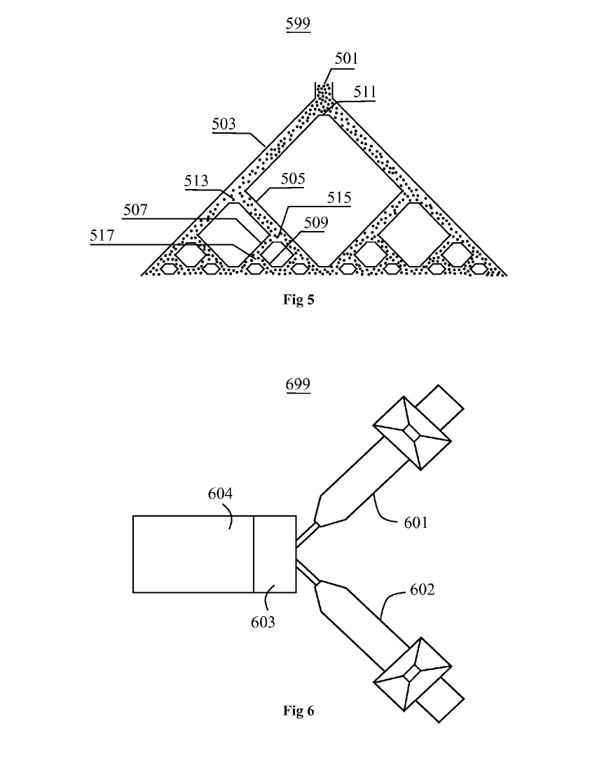

FIG. 6 illustrates a block diagram of an injection molding apparatus 699 for manufacturing objects with varying concentration of particles, according to an embodiment. Injection molding machine 601 and injection molding machine 602 inject liquids having different concentrations of particles into a mixing manifold 603. The two liquids merge into a single liquid that exits the mixing manifold to enter a mold 604, where the intended object is cast. The intended object may be a rod or sheet. In the case of a sheet, a system of channels that ensures same concentration areas are cast horizontally may be used before the sheet. The injection molding machines inject the two materials into the mold at rates which vary over time, such that the proportion of the two liquids being injected varies over time. This creates a changing concentration of the material being injected.

In an embodiment, the variation in material injection rate in the duration of the shot is achieved by changing the speed at which the injection takes place. Thus, for screw type injection molding machines, the two screws of the two injection molding machines are moving forward at rates which are different for the two machines and different at different points of time. In another embodiment, the pressure applied for the injection during the shot is varied per injection molding machine. In yet another embodiment, a variable sized reservoir such as a cylinder with a reciprocating piston is attached to the channel between the injection molding machine and the mixing manifold 603. This piston/pistons moves during the shot, thus creating different rates of material injection.

In another embodiment, the machines 601 and 602 are not injection molding machines, but extrusion machines which can extrude material at rates which vary over time. This variation of rates can be achieved by varying the speed of screws, by using reciprocating screws, by using cylinders with reciprocating screws at the output, or by using more than one of these strategies. The manifold 603 mixes the liquid from the two injection molding machines into a single liquid stream having a varying concentration of particles. This stream enters the object 604. 604 may be a mold of the shape of the final product (as used in injection molding), or it may be an extrusion die, i.e. an orifice having the shape of the cross section of the final product. The final product may be a rod or a sheet. In the case of a sheet, a system of channels will convert the single stream of liquid into the shape of the sheet, while ensuring that liquid that enters the channel at a given time exits different points on the sheet at the same time. This ensures the concentration variation remains in the extruded direction of the sheet, and there is no (or very less) concentration variation in the cross direction (across a cross sectional plane).

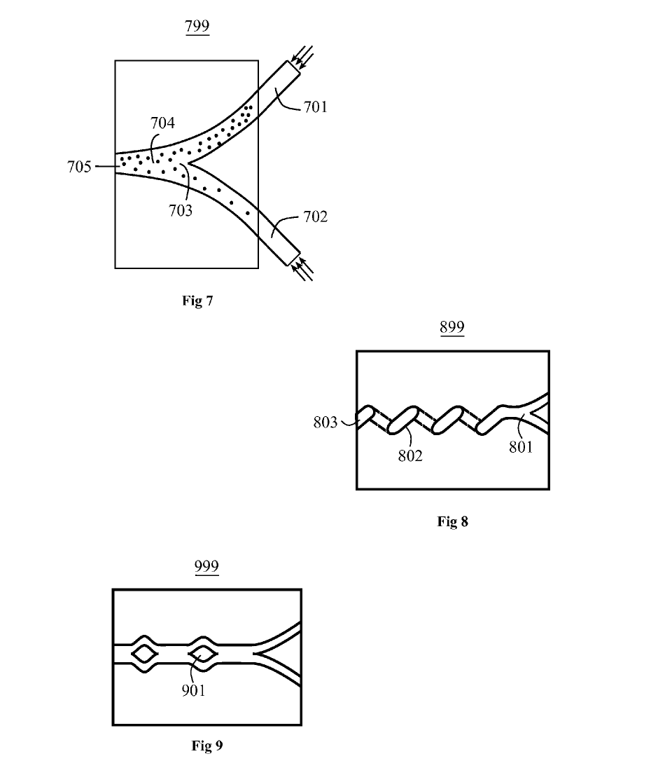

FIG. 7 illustrates a block diagram of a mixing manifold 799 that mixes two streams of liquids, according to one embodiment. Liquids from two injection molding or extrusion machines enter inlet 701 and inlet 702. These liquids merge at point 703 in the mixing manifold 799 and are conducted by channel 704, wherein the liquids mix further. The merged liquid exits the mixing manifold through outlet 705 where it is extruded into a sheet or a rod, or cast into a sheet or a rod, or other object.

In an embodiment, the inlets are of a tubular type, but the outlet is of a sheet type. The cross section of the channels have a shape which is tube like at one end and sheet like at the other end. In an embodiment, this change of shape from tube to a sheet is achieved before the point of merging 703, so that the liquids are in sheet form at the point at which they merge.

FIG. 8 illustrates a block diagram of a mixing manifold 899 that mixes two streams of liquids, according to one embodiment. After the liquids merge at point 801, they pass through a spiral or twisted passage 802 so that they are further mixed before exiting the mixing manifold 899 through outlet 803.

FIG. 9 illustrates a block diagram of a mixing manifold 999 that mixes two streams of liquids, according to one embodiment. The liquids are repeatedly separated and merged for higher level of mixing. The separation and merging may be on various axes. Obstacles such as 901 are introduced into the channel for mixing. A designer may come up with more complicated combinations of twists, spirals or other passage shapes, obstacles, and separations and merges to achieve the level of mixing desired.

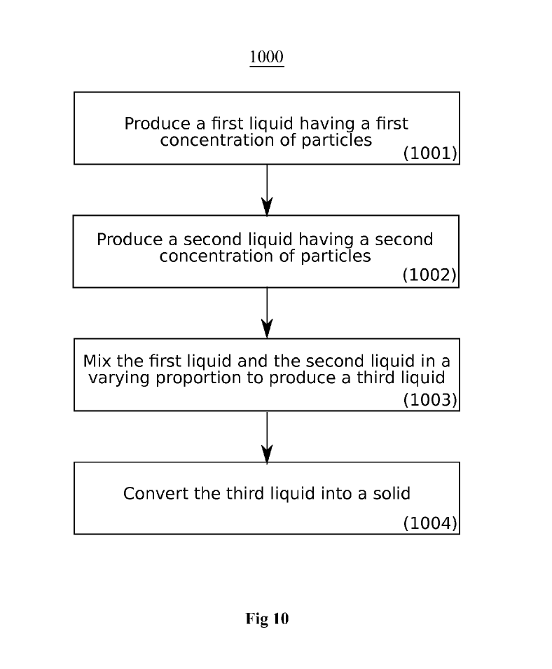

FIG. 10 illustrates a method 1000 of manufacturing an object with a varying concentration of particles, according to one embodiment. A first liquid having a first concentration of particles is produced (1001). A second liquid having a second concentration of particles is produced (1002). The first liquid is mixed with the second liquid to produce a third liquid (1003). In an embodiment, the first liquid and the second liquid are mixed in a proportion that varies over time, to produce a third liquid having a varying concentration of particles. In an embodiment, the method of producing the first liquid 1001, or the method of producing the second liquid 1002, or both these methods comprise producing these liquids at a varying flow rate. The flow rates of the two liquids are changed in such a way that they mix in different proportions at different moments of time. The third liquid is injection molded, cast, compression cast or extruded to form a solid object (1004). Other methods such as solvent evaporation or polymerization may be used to convert the liquid into a solid.

### OTHER EMBODIMENTS

In an embodiment, a continuous sheet or rod with a varying concentration of particles is continuously produced using a continuous extrusion process. The rod or sheet has a repeating pattern of concentrations. The continuous rod or sheet is then cut into discrete rods or sheets, each having one tile or instance of the repeating pattern, to produce a rod or sheet having a specified variation in particle concentrations.

In an embodiment, more than one species of particles are present in the base material, in the final object being created. If all of these particles vary according to the same concentration profile, or in concentration profiles which are related to each other by an affine function, then the species may be mixed in the two devices producing the two liquids at different concentrations, to get the final concentration profile. On the other hand, in certain applications, the concentration profiles of the different particles may be completely different. In this case, more than two devices producing liquid of different particle concentrations may be used. Liquid from these (more than two) devices (e.g. two extruders or injection molding machines) may be merged in a mixing device which may be an extruder, a mixing manifold or a channel or system of channels that mixes material.

In an embodiment, objects having a varying material composition are being created. Multiple devices producing liquids of different material composition feed these liquids to a mixing device. The proportion in which the different liquids are mixed is varied with time, to produce a liquid with varying material composition. This liquid is cast in a mold or extruded to give an object of varying material composition. All embodiments relating to liquids of different particle concentrations can be adapted to liquids of different material composition. The liquids produced by the different devices may be miscible or partly miscible, or may form a suspension in each other. The vigorous churning in the manifold or in an output extruder screw will help to mix the materials. In an embodiment, the different materials have the same or closely matched densities.

### Uses

A rod or sheet having a graded (varying) concentration of particles of a different refractive index, or pigment, dye or photoluminescent material may be used as a light source by shining light on one or both ends of the rod or sheet. The gradation in concentration helps achieve uniformity of extracted light, or any required pattern of light. Photoluminescent material or dye may be used to color the light, or to change the wavelength of light to a suitable wavelength. Photoluminescent material and light scattering material (usually particles of a different refractive index, or metallic particles or pigment) may be added together to impart required uniformity and color characteristics. The concentration profiles for photoluminescent material and light scattering material may be different. Furthermore, more than one kind of photoluminescent material or light scattering material may be used, each having different concentration profiles.

A continuous sheet having different properties in different parts may be created by creating a sheet having a varying material composition, or varying concentration of additives. For example a sheet may be flexible in one part and rigid in another part. This could be used to make components, such as electronic components. PCBs (printed circuit boards) which are flexible in some places and rigid in other can be used to flexibly bend to form couplings, etc. Such sheets may be used to produce displays which are partly flexible and partly rigid. In this case, the materials being mixed in varying proportions may be synthetic rubber and a compatible plastic.

As another example, a sheet may have different thermal properties in different parts. For example, it may be a good conductor of heat in some parts and a bad conductor of heat in another part. This may be used to create specialized heat exchangers.

Similarly sheets may have a continuous gradation of mechanical properties, for example elasticity, flexibility, modulus of elasticity, strength, density. In an automobile, a single sheet may be strong where required, and light in another place—this will improve safety and reduce weight at the same time. Similarly, in an airplane, a wing needs to be strong near the airplane hull, and light near the tips. This is done by structural design. Using the present invention, these designs may be improved by using sheets having mechanical properties which change along the surface.

Similarly, rods having different properties in different parts, such as flexibility, thermal properties, modulus of elasticity, strength, density, etc. may also be created and used to improve design of various objects.

1. A method comprising:
producing a first liquid having a first particle concentration,
producing a second liquid having a second particle concentration,
mixing the first and second liquids in a varying proportion to produce a third liquid having a varying particle concentration.

2. The method of claim 1 further comprising injection molding the third liquid to form a solid.

3. The method of claim 1 further comprising extruding the third liquid to form a solid.

4. The method of claim 1 wherein the first and second liquids are produced using an extruder.

5. The method of claim 1 wherein the step of mixing the first and second liquids in a varying proportion comprises introducing the first and second liquids at varying flow rates in a mixing device.

6. A method comprising:
producing a first liquid having a first material composition,
producing a second liquid having a second material composition,
mixing the first and second liquids in a varying proportion to produce a third liquid having a varying material composition.

7. An apparatus comprising,
a first device capable of producing a first liquid of a first particle concentration,
a second device capable of producing a second liquid of a second particle concentration,
a third device capable of mixing liquids from the first device and the second device to produce a third liquid.

8. The apparatus of claim 7, wherein the first device comprises an extruder with a screw.

9. The apparatus of claim 7, wherein the third device comprises a rotating screw.

10. The apparatus of claim 7, wherein the third device comprises a mixing manifold.

11. The apparatus of claim 7, wherein the third device is a channel capable of carrying liquids.

12. The apparatus of claim 7, wherein the third device is a system of channels capable of carrying liquids.

13. The apparatus of claim 7, wherein the first device is capable of producing liquid at a varying flow rate.

14. The apparatus of claim 13, wherein the first device has a screw with a variable rotation speed.

15. The apparatus of claim 13, wherein the first device has a reciprocating screw.

16. The apparatus of claim 13, wherein the first device comprises a cylinder with a reciprocating piston attached to a channel carrying the first liquid.

17. The apparatus of claim 10 wherein the mixing manifold comprises a system of channels having a geometry such that liquid entering the system at a particular time will leave the system at almost the same time.

18. The apparatus of claim 7 further comprising a mold for injection molding the third liquid.

19. The apparatus of claim 7 further comprising a die for extruding the third liquid to form a solid.
